(19) United States
(12) Patent Application Publication
(10) Pub. No.: US 2019/0235527 A1
(43) Pub. Date: Aug. 1, 2019

(54) METHOD AND SYSTEM TO REDUCE THE PENDULUM EFFECT OF A LOAD

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB); Justin SCHUHARDT, Montara, CA (US); Robert CANTRELL, Herndon, VA (US); Samantha M. MANGOSING, Bella Vista, AR (US)

(73) Assignee: Walmart Apollo, LLC, Bentonville, AR (US)

(21) Appl. No.: 16/264,287

(22) Filed: Jan. 31, 2019

Related U.S. Application Data
(60) Provisional application No. 62/624,681, filed on Jan. 31, 2018.

(51) Int. Cl. G05D 1/08; G05D 1/02; B64C 17/04; B64D 9/00; B64C 39/02

(52) U.S. Cl. CPC G05D 1/0816; G05D 1/0204; B64C 2201/128; B64D 9/003; B64C 39/024; B64C 17/04

(57) ABSTRACT

An assembly for reducing a pendulum effect of a package suspended from an unmanned aerial vehicle (UAV). The assembly includes a curved rail having a first rail connection and a second rail connection, the first rail connection and the second rail connection rotationally coupling the curved rail to a body of the UAV. The assembly includes a trolley assembly moveably coupled to the curved rail, the trolley assembly comprising a housing having a first trolley with four wheels and a second trolley with four wheels. The assembly includes a tether coupled to the housing of the trolley assembly, the tether configured to couple to the package. The assembly allows movement of the package in three-axes with respect to the UAV.

### CROSS REFERENCE TO RELATED APPLICATIONS

This present Patent Application claims priority benefit from U.S. Provisional Patent Application No. 62/624,681 filed on Jan. 31, 2018, the entire content of which is hereby incorporated herein by reference.

### TECHNICAL FIELD OF THE INVENTION

The present application relates to aerial vehicles having loads, such as packages, coupled thereto. More specifically, the present application relates to a method and system for reducing the pendulum sway effect of a load coupled to an unmanned aerial vehicle.

### BACKGROUND OF THE INVENTION

Currently, crane-based or winch-based unmanned aerial vehicle (UAV) package delivery mechanisms suffer from a load shift or pendulum effect during flight. The load shift or pendulum effect reduces flight efficiency and may unbalance the UAV leading to a catastrophic failure of the UAV. Thus, a need exists for a package delivery assembly which reduces the pendulum effect, improves stability, and reduces sway of the package.

### BRIEF SUMMARY OF THE INVENTION

According to an embodiment of the present disclosure, an assembly for reducing a pendulum effect of a package suspended from an unmanned aerial vehicle (UAV) may include a curved rail having a first rail connection and a second rail connection, the first rail connection and the second rail connection rotationally coupling the curved rail to a body of the UAV, a trolley assembly moveably coupled to the curved rail, the trolley assembly comprising a housing having a first trolley with four wheels and a second trolley with four wheels, a plurality of sensors configured to sense the pitch, yaw, and roll of the UAV; and a tether coupled to the housing of the trolley assembly, the tether configured to couple to the package. The assembly may allow movement of the package in three-axes with respect to the UAV in response to data sensed by the plurality of sensors.

According to an embodiment of the present disclosure, a method for reducing a pendulum effect of a package suspended from an unmanned aerial vehicle (UAV) may include coupling a package to the UAV with a package delivery system, the package delivery system having a rail, a tether, and a trolley assembly, transporting the package to a delivery location by flight of the UAV, and aligning the center of gravity of the package with the center of the UAV during flight of the UAV thereby reducing the pendulum effect of the package. Aligning the center of gravity of the package with the center of the UAV during flight of the UAV may include moving the package along the rail with the trolley assembly.

### BRIEF DESCRIPTION OF DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a schematic view of a UAV having a package delivery assembly, according to an embodiment of the present disclosure;

FIG. 2 shows a schematic view of the package delivery assembly of FIG. 1, according to an embodiment of the present disclosure;

FIG. 3A shows a schematic of the package delivery assembly of FIG. 1, according to an embodiment of the present disclosure;

FIG. 3B shows a cross-sectional view of the package delivery assembly of FIG. 3A, according to an embodiment of the present disclosure;

FIG. 4 shows a schematic of the package delivery assembly of FIG. 1, according to an embodiment of the present disclosure;

FIG. 5 shows a schematic of a control system according to an embodiment of the present disclosure; and

FIG. 6 shows a schematic of a control loop during flight of a UAV, according to an embodiment of the present disclosure.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. A person skilled in the relevant art would recognize that other equivalent parts can be employed and other methods developed without departing from the spirit and scope of the invention. All references cited herein are incorporated by reference as if each had been individually incorporated.

The present disclosure relates to a package delivery assembly for coupling to an aerial vehicle, such as a UAV. The package delivery assembly allows the package and UAV to move as an entire unit in correlation with the direction of flight for the drone in a 3-axis system. The package delivery assembly may include a rail having a trolley affixed thereto for traveling along the rail. A tether or cable may be coupled between the trolley and a package or load. The package delivery assembly may include two trolleys, each trolley having a tether coupled between the respective trolley and the package. The package delivery assembly may include sensors and one or more servos for controlling the movement of the package delivery assembly.

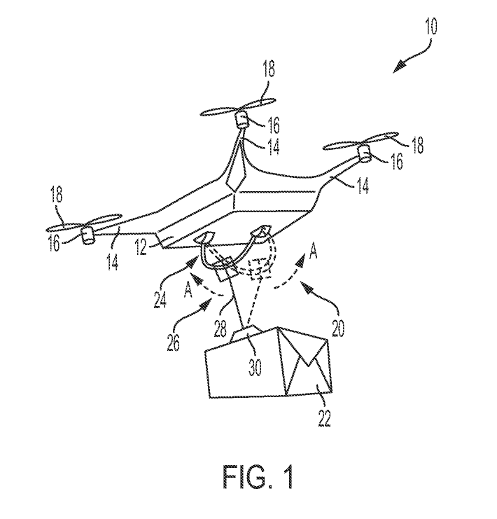

Referring to FIG. 1, a schematic view of an aerial vehicle or UAV 10 is shown. The UAV 10 may include a frame or body 12 having supports 14. The supports 14 provide support for motors 16 to drive propellers 18. The propellers 18 provide thrust for flight of the UAV 10. The UAV may include a package delivery assembly 20 for coupling to a package, parcel, or other load 22. The package delivery assembly 20 may include a rail assembly 24, a trolley assembly 26, a tether 28, and a package connection 30. The package connection 30 may be coupled or secured to the package 22. The tether 28 may be, for example, a cable, rope, chain, etc. The package connection 30 may be a direct connection to the package 22 or may be connected with or integral with a package delivery mechanism, such as a winch or crane.

During operation, the UAV 10 may be secured to the package 22 with the package delivery assembly 20 for transportation of the package 22 between locations. For example, the UAV 10 may transport the package 22 from a warehouse location to a delivery location to deliver the package 22 to a consumer. During flight, the package 22 may be suspended from a lower surface of the UAV 10. This suspension may cause the package 22 to move or swing during flight, creating a pendulum effect. The package delivery assembly 20 may include a trolley assembly 26 which travels along the rail assembly 24 to compensate or adjust for the sway or pendulum effect produced by the movement of the package 22 during flight. The package delivery assembly 20 may reduce or eliminate the pendulum or sway effect of the package's 22 load while maintaining or improving flight dynamics. The package delivery assembly 20 may allow the UAV 10 to remain balanced and improve stability of the UAV 10. The compensation or adjustment of the package delivery assembly may operate to maintain the package 22 and/or the UAV 10 in a steady state condition during flight. The steady state condition may be a condition where the package 22 and/or the UAV 10 is level and aimed in the proper direction of flight.

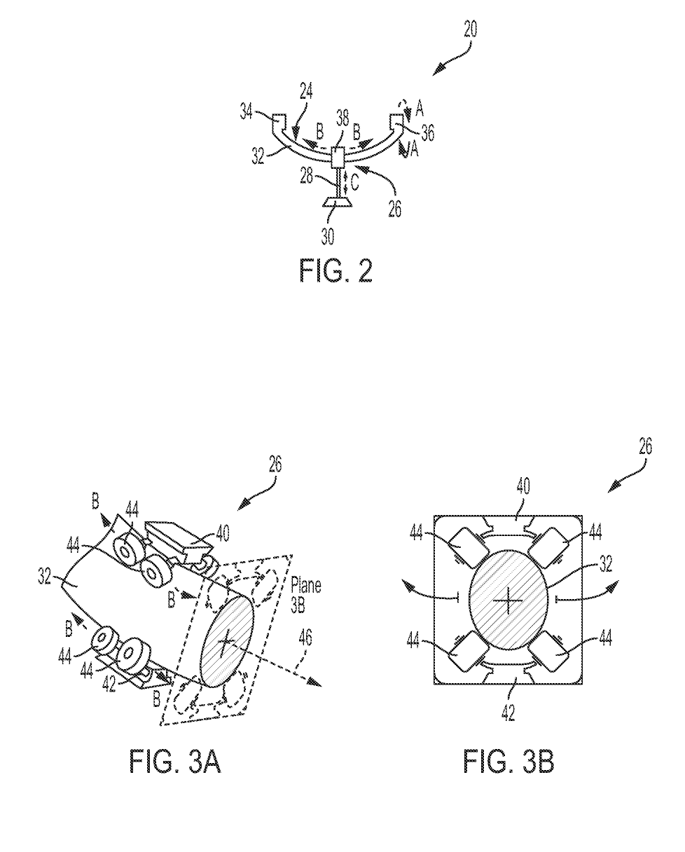

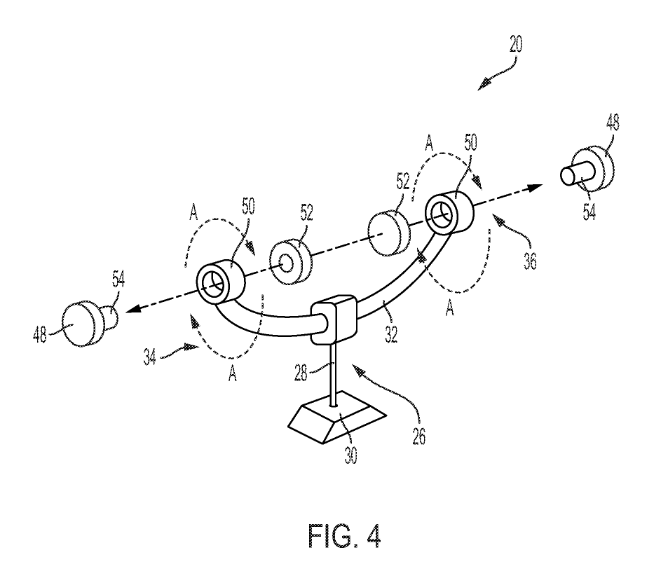

Referring to FIG. 2, the package delivery assembly 20 is shown with the package 22 and UAV 10 omitted for clarity. The rail assembly 24 of the package delivery assembly 20 may include a rail 32, a first rail connection 34, and a second rail connection 36. The rail 32 may be curved such that the rail 32 curves extending downward from the first rail connection 34 to a central point and curves extending upward to the second rail connection 36. The curvature of the rail 32 may allow for the package 22 to move along the rail 32 in the direction of arrows C. The first rail connection 34 and second rail connection 36 may couple the package delivery assembly 20 to the body 12 of the UAV 10, as depicted in FIG. 1 and as will be described with relation to FIG. 4. The first rail connection 34 and second rail connection 36 may allow for movement of the rail 32 in the direction of arrows A, for example, to rotate (see also FIG. 1).

With continued reference to FIG. 2, the trolley assembly 26 of the package delivery assembly 20 may include a housing 38 for protecting the trolleys 40, 42 from debris and/or for filling with a lubricant to reduce friction between the trolleys 40, 42 (FIG. 3A) of the trolley assembly 26 and the rail 32. The trolleys 40, 42 and thus housing 38 may be coupled to the rail 32 to allow movement in the direction of arrows B along the rail 32. The housing 38 may improve longevity of the package delivery assembly 20. The housing 38 may be coupled or attached to the tether 28 such that the tether 28 may be allowed to extend and contract in the direction of arrows C. The housing 38 may be coupled to the tether 28 with, for example, a crane, winch, or other retractable connection type. The tether 28 may be coupled to the package connection 30 and thus to the package 22.

Referring now to FIG. 3A, a schematic of the exemplary trolley assembly 26 is depicted with the housing 38 removed for clarity and referring also to FIG. 3B, a cross-sectional view of the trolley assembly 26 is depicted along the plane 3B of FIG. 3A. Within the housing 38 (FIG. 2), a first trolley 40 and a second trolley 42 may be coupled to the rail 32. The first trolley 40 and second trolley 42 may include wheels 44 for traversing the rail 32. The wheels 44 may allow the first trolley 40 and second trolley 42 to traverse the rail 32 to and fro in a generally longitudinal direction in the direction of arrows B and in a direction substantially parallel with the central axis 46 of the rail 32. The wheels 44 may alternatively be rollers, casters, discs, etc. The first trolley 40 and second trolley 42 may each include four wheels, however, more or fewer wheels may be provided. Although the first trolley 40 and second trolley 42 are depicted and described as traversing the rail 32 in a lateral or longitudinal direction along the length of the rail 32, it may be appreciated that the wheels 44 may be constructed such that the first trolley 40 and second trolley 42 may move along the rail 32 in a radial direction around the outer circumference of the rail 32 in addition to moving in a lateral or longitudinal direction. The first trolley 40 and the second trolley 42 may be connected to each other to move as or form a single unit.

Referring to FIG. 4, the package delivery assembly 20 is depicted with the UAV 10 (FIG. 1) and the package 22 (FIG. 1) removed for clarity. The rail 32 of the package delivery assembly 20 may include the first rail connection 34 and the second rail connection 36. The first rail connection 34 may include an end 48, a rail connector 50, and a cap 52. The end 48 may be fixedly secured to or formed unitarily with the body 12 (FIG. 1) of the UAV 10. The end 48 may include a protrusion 54. The protrusion 54 may extend through an opening in the rail connector 50. The rail connector 50 may be fixedly secured to or formed unitarily with the rail 32. The rail connector 50 may be secured to the end 48 with a cap 52. The cap 52 may thread onto an end of the protrusion 54. Alternatively, the cap 52 may be secured to the protrusion 54 in any other manner, such as glue, adhesion, welding, etc., so long as the rail connector 50 is retained on the protrusion 54 and is permitted to move relative to the protrusion 54.

As may be appreciated, the protrusion 54 and the rail connector 50 have complimentary profiles such that the rail connector 50 is permitted to rotate relative to the protrusion 54 in the direction of arrows A (corresponding to arrows A of FIGS. 1 and 2). Although the end 48 and rail connector 50 are depicted as having a generally circular cross-section, it may be appreciated that the cross-sectional shape of the end 48 and rail connector 50 may be any shape so long as a rotational movement of the rail connector 50 with respect to the end 48 is permitted.

With continued reference to FIG. 4, the second rail connection 36 may include an end 48, rail connector 50, protrusion 54, and cap 52 which may be the same as previously described with relation to first rail connection 34. When assembled, the first rail connection 34 and the second rail connection 36 may allow for rotation of the rail 32 in the direction of arrows A during flight of the UAV 10 (FIG. 1). The rotation of rail 32 may rotate the trolley assembly 26, tether 28, package connection 30, and package 22 (FIG. 1). The rotation of rail 32 relative to UAV 10 through rail connections 34, 36 may be caused by the movement of the center of gravity of the package 22 during flight, as will be described.

In an alternative embodiment, the package 22 (FIG. 1) may be coupled to the UAV 10 with two or more tethers 28. In an exemplary embodiment where two tethers 28 are employed, a second trolley assembly 26 may be provided along the same rail 32 or along a second rail 32. The second rail 32 may be located parallel to the first rail 32. Where two trolley assemblies 26 are provided, either on the same or different rails 32, both trolley assemblies 26 may compensate for the sway or pendulum effect of the package 22. The trolley assemblies 26 may be controlled by the natural center of gravity of the package 22 or may be controlled by a servo, as will be described. The second trolley assembly 26 and/or second rail 32 may be the same as the trolley assembly 26 and rail 32 previously described.

The UAV 10 may further include sensors and/or cameras to monitor the package 22 and detect sway or pendulum effect of the package 22. The package delivery assembly 20 may be controlled, either autonomously by the UAV or remotely, in response to information detected by the sensors. The sensors may be any sensors capable of detection motion or change of position, such as gyroscopes or accelerometers, and/or cameras, etc.

It may be appreciated from the foregoing disclosure that during flight of the UAV 10 (FIG. 1), the package 22 (FIG. 1) may create a load force on the UAV. This load force may be caused by the pendulum or sway effect the package creates by the nature of it extending downward from the UAV 10. The package delivery assembly 20 may counter this effect by allowing the package 22 to move in the directions of arrows A, B, and C, thus adjusting for the sway or pendulum effect generated during flight. The package delivery assembly 20 is a rail-based system where a first trolley 40 having four wheels and a second trolley 42 having four wheels may be affixed to an may travel along the rail 32. This may allow the trolleys 40, 42 to shift the weight across a horizontal axis (X-axis), the direction of arrows B, of the UAV 10 and may allow the trolleys 40, 42 to shift the weight in the direction of arrows A (Z-axis) of the UAV 10. The rail 32 is curved allowing for the trolleys 40, 42 to shift the weight across the vertical (Y-axis), the direction of arrows C, of the UAV 10. The rail 32 is coupled to the UAV 10 at the first rail connection 34 and the second rail connection 36 allowing the package delivery assembly 20 to pivot, shifting weight in the direction of arrows A (Z-axis) of the UAV 10. The package delivery assembly 20 may also allow for vertical (up and down) movement of the package 22 with respect to the body of the UAV 10 due to the tether 28 being actuated to extend and retract in a vertical (up and down) direction.

Because the package delivery system 20 has free movement in three axes, the weight of the package 22 may correspond with its natural center of gravity. As the weight of the UAV 10 shifts in one direction or another, due to the shifting of the package 22 during flight, the natural center of gravity of the package 22 may move or pull the package delivery assembly 20 along the rail 32 in a manner corresponding with the UAV 10. The movement of the package 22 along the rail 32 during flight may reduce the pendulum and sway effect, improve stability, and allow for more efficient flight of the UAV 10. This solution may require considerable movement of the UAV to counter the swaying and also to provide the third degree of freedom. As noted, this solution may require a manner in which the UAV can sense or monitor what the package 22 is doing (e.g. the motion, direction, speed, etc.). The UAV may sense or monitor shifts in weight and alignment against a target to assist in compensating and adjusting for the sway of the package.

Additionally, the package delivery system may be controlled through a servo (not depicted) connected to the flight controller (not depicted) of the UAV 10. The servo may control the trolleys 40, 42 and/or the rail connections 34, 36 such that adjustments to the trolleys projection and/or direction may be controller autonomous by the UAV 10 or remotely by a user or remote computer for the UAV 10. The servo may also control a crane or winch associated with the package delivery assembly 20. The servo may be controlled in a manner to maintain the package 22 centered and with reduced pendulum movements.

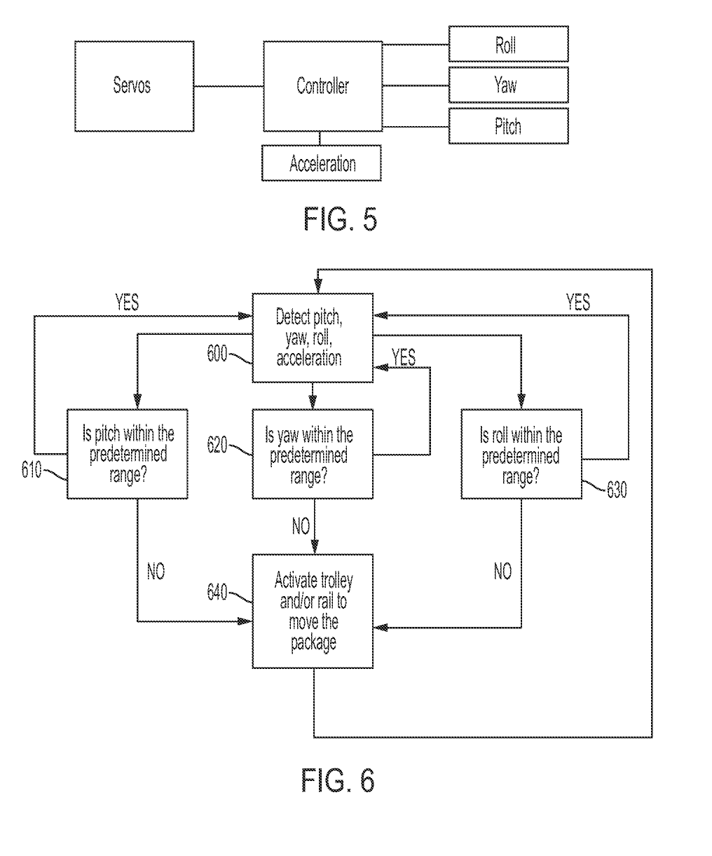

For example, each rail connection 34 and 36 may be provided with a servo and the trolleys 40, 42 may each be provided with a servo (or a single servo may be provided to control both trolleys 40, 42). As shown in FIG. 5, the UAV 10 may be provided with a plurality of sensors, for example, a gyroscope or other sensors which detect pitch, yaw, and/or roll. The UAV 10 may also include an accelerometer. The UAV 10 may include a controller programmed to include baseline ranges for pitch, yaw, and roll when the UAV 10 is not provided with a package. That is, the UAV 10 may be programmed to include a preferred range for each of pitch, yaw, and roll such that the center of gravity of the UAV 10 is in the proper position to minimize or eliminate any sway or pendulum effect. During flight with a package, the sensors may sense the pitch, yaw, and roll. One or more sensors may detect these parameters and provide them as input to the controller. The controller may compare the sensed values to the predetermined range. If the sensed value is outside of the predetermined range of values programmed into the UAV 10, the appropriate servo may be actuated to move the package in the necessary direction (e.g. in the direction of arrows A, B, C, or combinations thereof) to align the center of gravity of the package with the center of gravity of the UAV 10 to maintain the sway or pendulum effect to a minimum or to zero. Smart sensors which perform the comparison may also be used.

As may be appreciated from the schematic of FIG. 6, during flight of the UAV 10, at step 600, the sensors may detect the pitch, yaw, and roll of the UAV 10. In step 610, if the pitch falls outside of the predetermined calibration range programmed into the UAV 10, then the loop may move to step 640 and one or more of the servos associated with one or more of the first trolley, the second trolley, and the rail, may be actuated to move the package. The pitch may again be sensed, if the pitch falls within the range, no action of the servo may occur. The sensing may occur at predetermined intervals, for example, continuously or once every 5 minutes, once every hour, etc. Similarly, in steps 620 and 630 the yaw and roll maybe sensed, respectively. If the sensed data falls outside of the predetermined range, then the system may move to step 640 to actuate one or more of the servos. If in any of steps 610, 620, and 630 the sensed parameters fall within the predetermined range, then no action need be taken for that parameter and the system may continue to perform the sensing at the predetermined intervals. It may be appreciated that the steps 610, 620, and 630 may be performed simultaneously, or in an alternating manner, or sequentially. That is, the pitch, yaw, and/or roll may be sensed simultaneously and the servos may be actuated to accommodate differences in pitch, yaw, and roll collectively. Thus, by sensing the pitch, yaw, and roll of the UAV 10, the center of gravity of the UAV 10 and the package may be maintained in a position that reduces or eliminates the sway or pendulum effect of the package.

The package delivery assembly 20, including the trolley assembly 26, may adjust the position of the package 22 to align the static center of force of the package 22 with the center of the UAV 10. The package delivery assembly 20 may also allow for dynamic movement of the trolley assembly 26 to offset the pendulum action of the package 22. The tethered package 22 may be used as a tail (stabilizer for the UAV 10). The trolley assembly 26 may also act to reduce the pendulum effect while the package 22 is being lowered by tether 28 for delivery. The trolley assembly 26 may move to reduce the pendulum effect or two arms having elbows (not depicted) could depress the tether 28 as the tether 28 supports the package 22 during the lowering process.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. An assembly for reducing a pendulum effect of a package suspended from an unmanned aerial vehicle (UAV), the assembly comprising:
a curved rail having a first rail connection and a second rail connection, the first rail connection and the second rail connection rotationally coupling the curved rail to a body of the UAV;
a trolley assembly moveably coupled to the curved rail, the trolley assembly comprising a housing having a first trolley with four wheels and a second trolley with four wheels;
a plurality of sensors configured to sense the pitch, yaw, and roll of the UAV; and
a tether coupled to the housing of the trolley assembly, the tether configured to couple to the package,
wherein the assembly allows movement of the package in three-axes with respect to the UAV in response to data sensed by the plurality of sensors.

2. The assembly of claim 1, wherein the housing is filled with lubricant to reduce friction between the first trolley and the curved rail and between the second trolley and the curved rail.

3. The assembly of claim 1, wherein the trolley assembly is configured to move longitudinally and vertically along the curved rail.

4. The assembly of claim 1, wherein the trolley assembly is configured to move relative to the UAV due to movement of the package, the trolley assembly configured to align the center of gravity of the package with the center of the UAV.

5. The assembly of claim 1, further comprising a servo coupled to the UAV for controlling the trolley assembly.

6. The assembly of claim 5, wherein the servo is autonomously controlled by the UAV in response to information received by the UAV from the plurality of sensors.

7. The assembly of claim 5, wherein the servo is remotely controlled.

8. The assembly of claim 1, further comprising a second trolley coupled to the package with a second tether.

9. The assembly of claim 8, wherein the trolley and the second trolley are both configured to move to align the center of gravity of the package with the center of the UAV.

10. (canceled)

11. (canceled)

12. (canceled)

13. (canceled)
